(19) United States
(12) Patent Application Publication
(10) Pub. No.: US 2010/0015425 A1
(43) Pub. Date: Jan. 21, 2010

(54) METHOD FOR MAKING A REINFORCEMENT FRAME AND SEALING MEMBRANE INCLUDING SUCH FRAME, AND PRODUCTS THUS OBTAINED

(75) Inventors: Pierre-Etienne Bindschedler, Obernai (FR); Marie Valentin, Illkirch (FR); Remi Perrin, Bischoffsheim (FR)

Correspondence Address: YOUNG & THOMPSON, 209 Madison Street, Suite 500, Alexandria, VA, 22314, US

(73) Assignee: SOPREMA, Strasbourg (FR)

(21) Appl. No.: 12/527,089

(22) PCT Filed: Feb. 13, 2008
(86) PCT No.: PCT/FR08/50238

§ 371 Date: Aug. 13, 2009

(30) Foreign Application Priority Data
Feb. 14, 2007 (FR) 0753247

(51) Int. Cl. D04H 5/02; D04H 5/04; D04H 5/06; B32B 5/00

(52) U.S. Cl. 428/219; 156/148; 264/103; 442/408

(57) ABSTRACT

The invention relates to a method for making a non-woven mat to be used as a reinforcement for a frame in a flexible sealing membrane. The method is characterised in that it includes providing vegetable-origin natural fibres optionally mixed with a minority of thermoplastic or thermofusible fibres, forming a non-woven mat or web by mechanical, pneumatic or hydraulic batting, submitting the web to two successive consolidation operations including a needle punching operation and a binding operation with a chemical binder or by a thermal processing preferably under pressure, and finally submitting the non-woven consolidated web to a process for the hydrophobation of the fibres.

This invention relates to the field of sealing, particularly of building structures and engineering structures, and in particular products in the form of prefabricated flexible coatings of the frame-membrane type and their process of production.

The objects of the invention are more particularly a process for the production of a frame for a sealing membrane, the frame that is obtained by this process, a process for the production of a sealing membrane that comprises a frame of the above-mentioned type, and the membrane that is obtained by this process.

Currently, the sealing membranes, generally of bituminous type, occupy a prominent place in the sealing of the substrates of flat covers, such as, for example, terrace roofing or the upper parts of works or structures.

The ease of installation and the exceptional durability of this type of product have helped make it the traditional solution in sealing material.

The above-mentioned advantages and performance result from the simultaneous reflective selection of a bituminous binder that is perfectly formulated to withstand weather damage and a reinforcement (or frame) that is perfectly adapted to the mechanical stresses of the membrane that are applied to its substrate.

Actually, the reinforcements have as their object to endow the sealing membranes with the structural durability and the various mechanical characteristics that are necessary: resistance to traction, tearing, perforation . . . .

In contrast, these reinforcements serve, during the production of the membrane, as a substrate for coating the bitumen that is applied hot (approximately 180° C.). It is then understood that another basic element to be considered is the strength and the temperature resistance of these reinforcements, as well as the resistance to tearing and the essential absence of shrinkage.

Taking into account these two types of stresses, two large families of reinforcements can currently be demonstrated, namely the reinforcements with uniform structure, such as grids, fabrics or materials (glass or polyester) and the reinforcements with random structure such as the non-woven materials (glass fabric; non-woven polyester).

Composite reinforcements that are formed by the combination of a fabric or a grid with a non-woven material are also known.

Nevertheless, these different types of frames have drawbacks that are greatly detrimental within the context of durable development.

Actually, these known frames use materials that are derived from fossil and non-renewable raw materials, require large amounts of energy for their production and their transformation, and/or are difficult and even impossible to recycle.

More specifically, it is possible to note the following points:
Use of polyester: organic material obtained from petrochemistry,
Use of glass: raw material that is easily recyclable but is a high consumer of energy (fusion at approximately 1,600° C.).

These various negative factors are particularly detrimental within the framework of the ICV (inventory of the life cycle) of products and endow the latter with a quite unfavorable ACV (analysis of the life cycle) result.

Although the use of fibrous materials of natural origin seems to constitute a possible approach for solving the problem that is posed, these materials also have major drawbacks, such as their hydrophilic nature, and, based on their nature, their durability and their limited mechanical performance. Taking into account these various negative factors, one skilled in the art is actually turned away from a possible use of natural fibers in the field of sealing.

This prejudice against the natural fibers is reinforced by the total abandonment, at least two decades ago, of the bitumen-impregnated jute fabric as a sealing product precisely because of the above-mentioned limitations that involved premature aging, swelling, and even breakdown and decomposition of these fabrics.

Taking the opposite view to these prejudices, this invention proposes a process for the production of a non-woven layer (with random and non-oriented distribution of fibers) that is designed to be used as a reinforcement or frame in a flexible sealing membrane, characterized in that it consists in providing natural fibers of plant origin, optionally mixed with minority thermoplastic or thermosetting fibers, in forming a non-woven fabric or a non-woven layer by mechanical, pneumatic or hydraulic napping, then in subjecting said fabric to two successive consolidation operations comprising a needle-bonding operation and a binding operation by a chemical binder or by heat treatment, preferably under pressure, and, finally, in subjecting the consolidated, non-woven fabric fibers to a treatment for making the fabric water-repellent.

It also proposes a process for the production of a flexible sealing membrane, using as a frame a layer that is obtained by the above-mentioned production process.

Finally, the invention also relates to a layer and a membrane that are obtained respectively by means of one and the other of the processes that are mentioned above.

Within the framework of the process for the production of the non-woven frame mentioned above, the napping density is regulated in such a way that the grammage or the surface mass of the resulting layer is between 50 and 400 g/m, advantageously between 80 and 300 g/m², and preferably on the order of approximately 150 g/m². The consolidation operations are carried out to reduce the thickness of the layer in such a way that its thickness at rest, in the absence of stress, is less than 2 mm, preferably on the order of 1 mm.

The production parameters of the layer are adjusted to obtain a resulting layer that has a sufficient porosity to allow its impregnation by the sealing binder under good conditions and with adequate adhesion.

By way of example, the mean diameter of the pores of the resulting layer can be on the order of 100 μm, and even 200 μm. Nevertheless, diameters of pores that are less than these values are also acceptable.

According to a first variant embodiment, to form completely or primarily the non-woven fabric, the process consists in providing natural fibers in the form of plant fibers that may or may not be treated, selected from the group that is formed by the fibers of linen, cotton, jute, hemp, bamboo, kenaf, and sisal, as well as mixtures of two or more of the various above-mentioned fibers (mixtures of at least two such fibers).

Preferably, the plant fibers, which may or may not be treated, primarily consist of linen fibers, in the form of oakum made of linen and/or refined linen fibers.

The term primarily is defined in this document as at least 50% by weight of the resulting layer, preferably on the order of 75% by weight or more.

According to a second variant embodiment, the process consists in providing natural fibers in the form of fibers made of synthetic material(s) of plant origin, selected from the group that is formed by the viscose fibers, the synthetic fibers that are derived from cellulose (for example of the LYOCELL type (filed name) of the LENZING Company), and the possible mixtures of these fibers.

So as to end simultaneously in a significant interlacing of the fibers, a compacting of the layer and a release of the pectin that is present in the fibers (forming a natural binder for the latter after cross-linking), the needle-bonding operation consists in a needle bonding by pressurized liquid jets or a spunlace operation, optionally preceded by a mechanical needle bonding.

The hydrophobic nature of the natural fibers can be achieved by various known processes for making the fibers water-repellent, provided that they preserve the mechanical characteristics of the fibers and the porous nature (mean porosity) of the frame, do not significantly increase the mass of the frame and do not negatively influence the adhesion of the sealing binder to said plant or natural fibers.

The basic principle that is used for this purpose by the invention to prevent the degradation and the aging of the fibers consists in producing an individual coating of these fibers by a hydrophobic agent.

Taking into account the considerations disclosed above, and according to a preferred embodiment, the treatment for making the material water-repellent, also enhancing the adhesion properties of the sealing binder, consists in grafting fatty acid chlorides onto the structures of the natural fibers of the non-woven fabric by an operation of chemical grafting by chromatogeny, preferably after consolidation.

Advantageously, the quantity of grafted fatty acid chlorides represents less than 1% by weight of the mass of natural fibers, advantageously less than 0.5% by weight, and preferably between 0.2 and 0.3% by weight, and the grafted fatty acid chlorides are selected from the group that is formed by the palmitic acid chlorides and the stearic acid chlorides.

The above-mentioned grafting operation can be derived from, for example, the one that is described in European Patent No. 1 007 202 and in U.S. Pat. No. 6,342,268, whose contents are integrated in this document by reference.

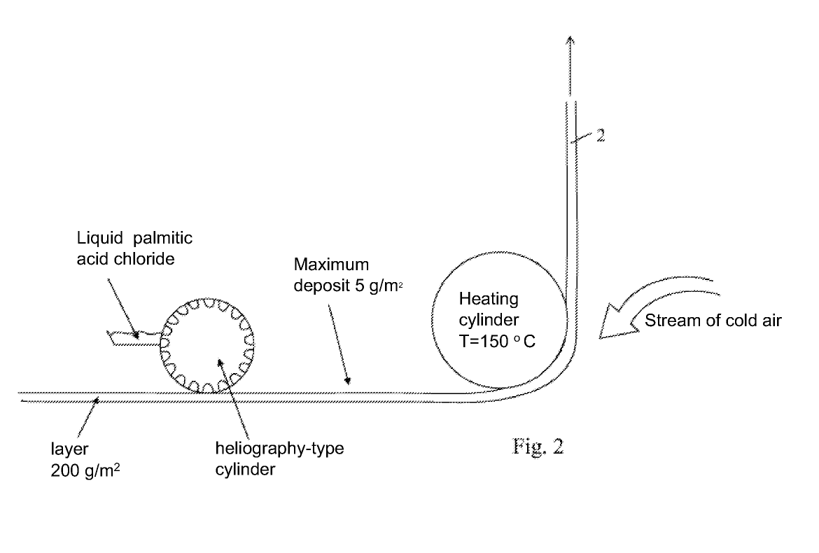

FIG. 2 of the accompanying drawing diagrammatically illustrates an installation that makes it possible to carry out the above-mentioned grafting operation on a consolidated layer. As this figure shows, the fatty acid chloride is deposited by standard printing techniques at a rate of about 5 g/m². The passage over the heating cylinder vaporizes the acid chloride that is grafted (it is in the gas phase) onto the hydroxyl groups (OH) of the natural fibers.

This reaction takes place in 1 to 2 seconds and releases—as reaction residue—very small quantities of hydrochloric acid that are drawn in and then condensed.

Furthermore, the inventors have noted that such a treatment that makes material water-repellent enhances the adhesion of a possible additional binding agent.

According to one characteristic of the invention, favorable in terms of ACV, the binder, connected during the chemical binding operation of plant fibers, is a chemical binding agent of plant origin, for example a binder that is selected from the group that is formed by the binders that are based on gluten or starch, in particular corn.

In addition to the above-mentioned examples of binders of plant origin, such a binder can also be selected from among collophane ester (polymer of abietic acid—aqueous dispersion resin), soy glue (proteinic in nature), casein (proteinic in nature—dry material in aqueous phase), and natural rubber latex (polyisoprene+proteins—in aqueous phase).

As a variant, the process can consist in producing a binding or a consolidation by pressurized heat treatment, for example by hot calendering, whereby the non-woven fabric consists of an essentially homogeneous mixture of natural fibers (with a melting point of more than 250° C.) and thermosetting fibers of organic origin, with a melting point that is preferably between 200° C. and 250° C., whereby the percentage by weight of said thermosetting fibers in the mixture is less than 20%, preferably on the order of about 10%.

When the application in question and/or the coating conditions require(s) it, the process can also consist in combining an additional reinforcing structure with a non-woven fabric of natural fibers by integrating it in said fabric during napping or during consolidation, or by connecting it to one of the surfaces of the latter, whereby said reinforcement is also able to be coated or impregnated with a sealing binder, whereby said additional reinforcing structure is advantageously selected from the group that is formed by glass grids, polyester grids, and grids made of a natural material, for example based on plant fibers, such as linen, cotton or the like.

Such reinforcing structures (of synthetic material) and their process for the production and integration are described, for example, in the documents FR-A-2 792 951, EP-A-1 226 299 and EP-A-0 285 533, although they are not combined with a layer of natural fibers of plant origin.

In addition, it may be provided to subject the natural fibers, before napping or after obtaining the consolidated non-woven fabric, to an additional treatment by spraying or impregnation, with agents that can modify at least some of their mechanical, chemical and/or physical characteristics by increasing in particular their resistance to fire and to aging, their anti-root and anti-cryptogamic properties, and their hydrophobic nature.

By way of examples of the above-mentioned treatments, it is possible to cite:
Anti-root: impregnation of copper salt solutions,
Anti-fire: intumescent surface spraying (European Patent Application No. 94110187.5/0 634 515),
Anti-cryptogamic: emulsion biocide,
Hydrophobic: fluorinated derivatives of emulsions.

This invention also has as its object a non-woven layer that can constitute a reinforcing frame for a flexible sealing membrane, characterized in that it consists of a non-woven fabric 2 that is based on natural fibers, preferably of plant origin, produced by mechanical, pneumatic or hydraulic napping and having at least undergone a needle-bonding operation, a chemical or thermal binding operation, and a treatment for making its fibers water-repellent.

This layer is preferably obtained by the layer production process that is described above and the various characteristics and possibilities mentioned previously in terms of surface mass, types of natural fibers that are used to produce the layer and nature of a related binding agent, and additional reinforcing structure types (optionally integrated with the layer) apply to the non-woven layer that is also the object of the invention.

Such a layer, preferably obtained by means of the production process mentioned above, is formed by fibers that are made hydrophobic because of the presence of fatty acid chlorides that are grafted onto their structure, resulting from a chemical grafting by chromatogeny (treatment preferably carried out after formation of the layer and consolidation of the latter).

These grafted fatty acid chlorides are present with a weight level that is less than 1% by weight of natural fibers, advantageously less than 0.5% by weight, and preferably between 0.2% and 0.3% by weight, and they are preferably selected from the group that is formed by the palmitic acid chlorides and the stearic acid chlorides.

Furthermore, the natural fibers that constitute the layer may have undergone at least one additional treatment as mentioned above.

The purpose of such a treatment can be in particular to release the plant fibers from at least some of the easily degradable organic components while preserving the components with a long service life and without appreciably affecting the mechanical characteristics of said fibers.

This invention also has as its object a process for the production of a flexible sealing membrane, characterized in that it consists in producing a non-woven layer by implementing the process as described above, and then coating or printing this layer with a sealing binder on a suitable coating, impregnation or calendering line.

It can be considered, of course, to produce the layer that forms the frame and the sealing membrane continuously over two contiguous production lines.

Nevertheless, the sealing membrane preferably will be produced from prefabricated layers that are produced during a first production phase, based on the application.

The applied sealing binder can consist either of a bituminous binder, optionally based on a bitumen that is modified by polymers (for example, SBS bitumen, bitumen modified by a polyurethane or the like), or a plant binder, for example based on modified vegetable oil(s).

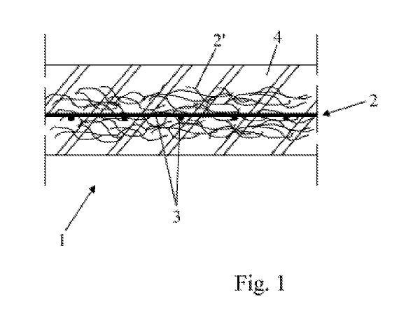

Finally, the invention also relates to a prefabricated flexible sealing membrane, obtained by coating or impregnation of a surface reinforcement or frame with a sealing binder. The accompanying FIG. 1 illustrates by way of nonlimiting example such a membrane 1 in the form of a partial cutaway view, whereby this membrane 1 is characterized in that the reinforcement 2 consists of a non-woven fabric or a non-woven layer based on natural fibers 2′, preferably of plant origin, having at least undergone a needle-bonding operation, an operation of chemical or thermal binding, and a treatment for making the material water-repellent, before its coating or impregnation by the binder 4.

The layer 2 that forms a reinforcement is obtained by the process of production described above, and the sealing membrane 1 is produced according to the production process mentioned above.

Furthermore, the sealing binder 4 can consist of a bituminous or plant binder as described above, and the layer 2 optionally can integrate an additional reinforcement grid 3.

By way of illustrative and nonlimiting example, a practical embodiment of the invention is described below in a detailed manner.

The production of a membrane according to the invention is generally carried out in two successive stages, namely a first stage for production of the non-woven layer that forms a reinforcement and a consecutive stage for production of the membrane itself.

Production of the Layer:

### 1) EXAMPLE 1

The following raw materials are selected:
Oakum made of linen, E0(3) quality, of the VAN ROBEYS Company (fiber length: 80/100 mm),
TENCEL, 1.7 dtex of the LENZING Company (fiber length: 38 mm).

A 75/25 mixture [oakum made of linen—Tencel]: 100 g/m² is produced.

A carding and then a mechanical napping are carried out.

A glass grid, with threads of 68 dtex (3 threads/cm in both directions) between the two layers of non-woven material (grammage of each layer: 100 g/m²), is introduced.

A spunlace operation (two injection nozzles working at a pressure of approximately 150 bar) is carried out.

A chemical binding with an SBR-type latex is carried out.

A drying in an oven at 160° C. is carried out.

The layer is then coated via a heliography cylinder with 3 g/m² of stearic acid chloride, and then passed to a heating cylinder at 140° C. (whereby the lower surface of the cylinder is ventilated with air at ambient temperature).

The reinforcement in layer form ultimately has a weight of 220 g/m² (quality control: capillary raise test with methylene blue<5 mm).

### 2) EXAMPLE 2

A mixing of oakum made of E2-quality linen of the VAN ROBEYS Company and copolyester fibers with a melting point at 240° C. is carried out. The mixture by weight is 25% of copolyester fibers and 75% of oakum made of linen (total grammage: 200 g/m²).

Then, a framing, followed by a pneumatic napping, is performed.

Next, a spunlace operation with 4 nozzles at 200 bar is applied to the layer, followed by a sizing operation in an aqueous solution of PHOBOTEX JVA of the HUNTSMANN Company so as to deposit 8 g/m² of PHOBOTEX on the fibers.

The layer is then treated in a drying oven at 160° C. and finally passes into a heating calender at 250° C. and 7 bar of pressure, so as to consolidate the layer thermally and to reduce its thickness to 0.8 mm.

Membrane Production:

The above-mentioned reinforcement that is obtained according to Example 1 or 2 is treated in a coating machine with 3 tanks:

Tank 1: Impregnation with a modified fluid bitumen that is very hot: 200° C.;

Tanks 2 and 3: Coating of binder on the lower surface of the reinforcement with an SBS bitumen-type binder with mineral feedstocks (12% of SBS/bitumen+SBS−30% of feedstocks).

Surface finishing is done with slate flakes, and the lower surface is covered with a 6 μm thermosetting film.

The final thickness of the membrane is approximately 3.0 mm.

Of course, the invention is not limited to the embodiments described. Modifications are possible, in particular from the standpoint of the composition of the various elements or by substitution of technical equivalents, without thereby exceeding the scope of protection of the invention.

1-35. (canceled)

36. Process for the production of a non-woven layer that is designed to be used as a reinforcement or frame in a flexible sealing membrane, characterized in that it consists in providing natural fibers of plant origin, optionally mixed with minority thermoplastic or thermosetting fibers, in forming a non-woven fabric or a non-woven layer by mechanical, pneumatic or hydraulic napping, then in subjecting said fabric to two successive consolidation operations comprising a needle-bonding operation by pressurized liquid jets and a binding operation by a chemical binder or by heat treatment, preferably under pressure, and, finally, in subjecting the consolidated, non-woven fabric fibers to a treatment for making the material water-repellent.

37. Process according to claim 36, wherein the napping density is regulated in such a way that the grammage or the surface mass of the resulting layer is between 50 and 400 g/m², advantageously between 80 and 300 g/m², and preferably on the order of about 150 g/m², and wherein the consolidation operations reduce the thickness of the layer in such a way that its thickness at rest, in the absence of stress, is less than 2 mm, preferably on the order of 1 mm.

38. Process according to claim 36, wherein to form completely or primarily the non-woven fabric, it consists in providing natural fibers in the form of plant fibers that may or may not be treated, selected from the group that is formed by the fibers of linen, cotton, jute, hemp, bamboo, kenaf, and sisal, as well as mixtures of two or more of the different above-mentioned fibers.

39. Process according to claim 38, wherein the plant fibers, which may or may not be treated, primarily consist of linen fibers, in the form of oakum made of linen and/or refined linen fibers.

40. Process according to claim 36, wherein the treatment to make the material water-repellent, also enhancing the adhesion properties of the sealing binder, consists in grafting fatty acid chlorides onto the structures of natural fibers of the non-woven fabric, by a chemical grafting operation by chromatogeny, preferably after consolidation.

41. Process according to claim 40, wherein the quantity of grafted fatty acid chlorides represents less than 1% by weight of the mass of natural fibers, advantageously less than 0.5% by weight, and preferably between 0.2 and 0.3% by weight.

42. Process according to claim 40, wherein the grafted fatty acid chlorides are selected from the group that is formed by the palmitic acid chlorides and the stearic acid chlorides.

43. Process according to claim 36, wherein the binder, connected during the operation of chemical binding of plant fibers, is a chemical binding agent of plant origin, for example a binder that is selected from the group that is formed by the binders based on gluten or starch, in particular corn, or from among the group that is formed by the collophane ester, soy glue, casein, and natural rubber latex.

44. Process according to claim 36, wherein it consists in producing a binding or a consolidation by pressurized heat treatment, for example by hot calendering, whereby the non-woven fabric consists of an essentially homogeneous mixture of natural fibers and thermosetting fibers of organic origin, with a melting point that is preferably between 200° C. and 250° C., whereby the percentage by weight of said thermosetting fibers in the mixture is less than 20%, preferably on the order of about 10%.

45. Process according to claim 36, wherein it also consists in combining an additional reinforcing structure with the non-woven fabric, by integrating it in said fabric, during napping or during consolidation, or by connecting it to one of the surfaces of the latter, whereby said reinforcement is also able to be coated or impregnated with the sealing binder.

46. Process according to claim 45, wherein the additional reinforcing structure is selected from the group that is formed by the glass grids, the polyester grids, and the grids made of a natural material, for example based on plant fibers, such as linen, cotton or the like.

47. Process according to claim 36, wherein it consists in subjecting the natural fibers, before napping or after obtaining consolidated non-woven fabric, to an additional treatment by spraying or impregnation, with agents that can modify at least some of their mechanical, chemical and/or physical characteristics, by increasing in particular their resistance to fire and to aging, their anti-root and anti-cryptogamic properties, and their hydrophobic nature.

48. Process for the production of a flexible sealing membrane, wherein it consists in producing a non-woven layer by implementing the process according to claim 36, and then in coating or printing this layer with a sealing binder over a suitable coating, impregnation or calendering line.

49. Process according to claim 48, wherein the sealing binder is a bituminous binder, optionally based on bitumen modified by polymers.

50. Process according to claim 48, wherein the sealing binder is a plant binder, for example based on modified vegetable oil(s).

51. Non-woven layer that can constitute a reinforcing frame for a flexible sealing membrane, wherein it consists of a non-woven fabric based on natural fibers of plant origin, produced by mechanical, pneumatic or hydraulic napping and having undergone two successive consolidation operations comprising one needle-bonding operation by pressurized liquid jets, a chemical or thermal binding operation, and a treatment for making its fibers water-repellent.

52. Layer according to claim 51, wherein the reinforcement has a surface mass of between 50 g/m² and 400 g/m², preferably on the order of 150 g/m², and a thickness that is less than 2 mm, preferably on the order of 1 mm.

53. Layer according to claim 51, wherein the natural fibers, forming only or primarily said layer, are plant fibers that may or may not be treated, selected from the group that is formed by the fibers of linen, cotton, jute, hemp, bamboo, kenaf and sisal, as well as the mixtures of at least two such fibers.

54. Layer according to claim 53, wherein the plant fibers that may or may not be treated primarily consist of linen fibers, in the form of oakum made of linen and/or refined linen fibers.

55. Layer according to claim 51, wherein the natural fibers are hydrophobic because of the presence of fatty acid chlorides that are grafted onto their structure, resulting from a chemical grafting by chromatogeny.

56. Layer according to claim 55, wherein the grafted fatty acid chlorides are present with a weight level that is less than 1% by weight of natural fibers, advantageously less than 0.5% by weight, preferably between 0.2% and 0.3% by weight, and they are preferably selected from the group that is formed by palmitic acid chlorides and stearic acid chlorides.

57. Layer according to claim 51, wherein the related binding agent, making the plant fibers integral with one another, is a binding agent of plant origin, for example a binder that is selected from the group that is formed by the binders based on gluten or starch, in particular corn.

58. Layer according to claim 51, wherein the related binding agent, making the plant fibers integral with one another, is a binding agent of organic origin with a low melting point, in particular between 200° C. and 250° C., for example in the form of thermoplastic synthetic fibers that are mixed essentially homogeneously with natural fibers of plant origin that form the fabric.

59. Layer according to claim 51, wherein it integrates an additional reinforcing structure, integrated in the thickness of the layer of natural fibers forming the fabric or connected to the latter, also able to be impregnated or coated with sealing binder.

60. Layer according to claim 59, wherein the additional reinforcing structure consists of a glass grid or a polyester grid.

61. Layer according to claim 59, wherein the additional reinforcing structure consists of a grid made of a natural material, in particular based on plant fibers, preferably linen or cotton.

62. Layer according to claim 51, wherein the natural fibers have also undergone an additional treatment, by spraying or impregnation, with agents that can modify at least some of their mechanical, chemical and/or physical characteristics by increasing in particular their resistance to fire and to aging, their anti-root and anti-cryptogamic properties, and their hydrophobic nature.

63. Prefabricated flexible sealing membrane, obtained by coating or impregnation of a surface reinforcement or frame with a sealing binder, membrane wherein the reinforcement consists of a non-woven fabric or a non-woven layer based on natural fibers of plant origin, produced by mechanical, pneumatic or hydraulic napping and having undergone two successive consolidation operations comprising one needle-bonding operation by pressurized liquid jets, and a chemical or thermal binding operation, and a treatment for making its fibers water-repellent, before its coating or impregnation.

64. Membrane according to claim 63, wherein the sealing binder is a bituminous binder, optionally based on bitumen that is modified by polymers.

65. Membrane according to claim 63, wherein the sealing binder is a plant binder, for example based on modified vegetable oil(s).
